(19) United States
(12) Patent Application Publication
(10) Pub. No.: US 2025/0151693 A1
(43) Pub. Date: May 15, 2025

(54) ELECTRIC FEED MIXER

(71) Applicant: Omni Powertrain Technologies, LLC, Houston, TX (US)

(72) Inventor: Vincenzo Vanni, Reggio Emilia (IT)

(21) Appl. No.: 18/940,033

(22) Filed: Nov. 7, 2024

Related U.S. Application Data
(60) Provisional application No. 63/597,501, filed on Nov. 9, 2023.

(51) Int. Cl. A01K 5/00; A01K 5/02; F16H 57/02; F16H 57/04

(52) U.S. Cl. CPC A01K 5/004; A01K 5/0266; F16H 57/0436; F16H 57/02; F16H 2057/02034; F16H 2057/02082

(57) ABSTRACT

A feed mixer assembly having a feed mixer platform on which is mounted a hopper with an auger assembly rotatably mounted therein. A first electric motor drives the auger via a main gearbox. A battery assembly on the platform provides electricity via a first inverter to power the electric motor. A control gearbox assembly mounted on the platform includes a three-way gearbox disposed to transfer power between a first driveshaft coupled to an external power source; a second driveshaft coupled to a pump, and a third driveshaft coupled to an electric motor/generator. Power from the external power source can be used to drive the pump and/or generate electricity from the electric motor/generator for storage by the battery. Alternatively, the electric motor/generator, powered by the battery, can be used to drive the pump.

### CROSS-REFERENCE TO RELATED APPLICATIONS

This application claims priority to U.S. Provisional Pat. App. No. 63/597,501, filed Nov. 9, 2023, which is incorporated by reference herein in its entirety.

### FIELD

This disclosure is directed to agricultural feed mixers, and more particularly to feed mixer power management and distribution.

### BACKGROUND

Electric feed mixers are essential agricultural devices designed for the efficient mixing of animal feed, often used in livestock and poultry farming. These mixers ensure that a uniform, nutritionally balanced feed is produced, meeting the dietary needs of various livestock and enhancing feed conversion rates and overall productivity.

Traditional feed mixers have primarily relied on mechanical or diesel-powered systems, which, while effective, are limited by factors such as high energy consumption, noise, and maintenance costs. The shift towards electric feed mixers addresses these concerns by leveraging electric motors to power the mixing process.

Despite these advances towards electric feed mixers, challenges remain in increasing energy efficiency, versatility, and power distribution of electric feed mixers. Therefore, there is a need for electric feed mixers that optimize energy efficiency, versatility, and power distribution.

### SUMMARY

As disclosed herein, a feed mixer assembly may comprise a feed mixer platform; a hopper having a base and mounted on the platform; an auger assembly extending from the hopper base and rotatably mounted relative to the base; a main gearbox assembly having an input shaft and an output shaft, the output shaft coupled to the auger; a first axial flux electric motor assembly having a driveshaft coupled to the input shaft of the main gearbox assembly; a first inverter mounted on the platform and electrically coupled to the first axial flux electric motor assembly; an electric battery assembly mounted on the platform and electrically coupled to the first inverter; a control gearbox assembly mounted on the platform and having a first driveshaft, a second driveshaft, and a third driveshaft, wherein the first driveshaft is an input shaft and the second driveshaft is an output shaft; a pump mounted on the platform and coupled to the second driveshaft; a second axial flux electric motor assembly mounted on the platform, the second axial flux electric motor assembly having a driveshaft coupled to the third driveshaft of the control gearbox assembly; and a second inverter mounted on the platform and electrically coupled between the second axial flux electric motor assembly and the battery.

In some examples, the second and third driveshafts of the control gearbox assembly may be aligned. The second and third driveshafts of the control gearbox assembly may be selectively coupled together. The feed mixer assembly may further comprise an external electricity source electrically coupled to the battery, and the external electricity source may be a power grid. The feed mixer assembly may further comprise a power source detachably coupled to the first driveshaft of the control gearbox, and the power source may be an engine or the power take off of a tractor.

In some examples, the pump may be an oil pump or hydraulic pump. The pump may be in fluid communication with the main gearbox assembly.

In some examples, the feed mixer assembly may further comprise at least two auger assemblies, each may be vertically extending from the hopper base and rotatably mounted relative to the base; at least two main gearbox assemblies, each may have an input shaft and an output shaft, the output shaft coupled to an auger; at least two first axial flux electric motor assemblies, each may have a driveshaft coupled to the input shaft of a separate main gearbox assembly; and a least two first inverters mounted on the platform, each may be electrically coupled to a separate one of the first axial flux electric motors. The control gearbox assembly may further comprise a first clutch to selectively couple the first driveshaft to the third driveshaft and a second clutch to selectively couple the second driveshaft to the third driveshaft.

In some examples, the main gearbox assembly may comprise a planetary gearset disposed along a main gearbox axis, and the driveshaft of the first axial flux electric motor may be disposed along the main gearbox axis. The pump may be in fluid communication with the first and second clutches. The first and second clutches may be electric clutches, hydraulic clutches or pneumatic clutches.

As disclosed herein, a feed mixer assembly comprises a feed mixer platform; a hopper mounted on the platform; an auger assembly within the hopper and rotatably mounted relative to the hopper; a main gearbox assembly having an input shaft and an output shaft, the output shaft coupled to the auger; a first electric motor assembly having a driveshaft coupled to the input shaft of the main gearbox assembly; a first inverter mounted on the platform and electrically coupled to the first electric motor assembly; an electric battery mounted on the platform and electrically coupled to the first inverter; a control gearbox assembly mounted on the platform and having a first driveshaft, a second driveshaft, and a third driveshaft, wherein the first driveshaft is an input shaft and the second driveshaft is an output shaft; a pump mounted on the platform and coupled to the second driveshaft; a second electric motor assembly mounted on the platform, the second electric motor assembly having a driveshaft coupled to the third driveshaft of the control gearbox assembly; and a second inverter mounted on the platform and electrically coupled between the second electric motor assembly and the battery.

As disclosed herein, the second electric motor assembly may be an axial flux electric motor and the first electric motor assembly may be a radial flux electric motor. The second electric motor may comprise an electric motor and an electric generator. The auger assembly may be vertically oriented. The auger assembly may be horizontally oriented.

As disclosed herein, the feed mixer platform may be a skid. The feed mixer platform may be a wheeled trailer.

As disclosed herein, a farming assembly may comprise a platform; an auger assembly at least partially supported on the platform; a main gearbox assembly having an input shaft and an output shaft, the output shaft coupled to the auger assembly; a first axial flux electric motor assembly having a driveshaft coupled to the input shaft of the main gearbox assembly; a first inverter mounted on the platform and electrically coupled to the first axial flux electric motor assembly; an electric battery assembly mounted on the platform and electrically coupled to the first inverter; a control gearbox assembly mounted on the platform and having a first driveshaft, a second driveshaft, and a third driveshaft, wherein the first driveshaft is an input shaft and the second driveshaft is an output shaft; a pump mounted on the platform and coupled to the second driveshaft; a second axial flux electric motor assembly mounted on the platform, the second axial flux electric motor assembly having a driveshaft coupled to the third driveshaft of the control gearbox assembly; and a second inverter mounted on the platform and electrically coupled between the second axial flux electric motor assembly and the battery.

Other examples include corresponding methods, computer systems, apparatus, and computer programs recorded on one or more computer storage devices, each configured to perform the actions described herein.

Features which are described in the context of separate aspects and embodiments of the invention may be used together and/or be interchangeable. Similarly, features described in the context of a single embodiment may also be provided separately or in any suitable subcombination.

### BRIEF DESCRIPTION OF THE DRAWINGS

FIGS. 1a, 1b and 1c each illustrate a simplified schematic diagram of an electric feed mixer assembly, according to some examples.

FIG. 2 is a side view of an electric feed mixer assembly with a portion of a hopper wall removed, according to some examples.

FIG. 3 is an orthogonal view of a main gearbox assembly, according to some examples.

FIG. 4 is a perspective view of a main gearbox assembly, according to some examples.

FIG. 5 is an orthogonal view of a reduction gear train assembly, according to some examples.

FIG. 6 is a section view of an axial flux electric motor assembly, according to some examples.

FIG. 7 is a simplified schematic diagram of an electric feed mixer assembly, according to some examples.

FIG. 8 is a simplified schematic diagram of operation of a control gearbox assembly, according to some examples.

FIG. 9 is a perspective view of an electric feed mixer assembly, according to some examples.

FIG. 10 is an illustrative method for controlling power distribution for an electric feed mixer assembly.

Examples of the present disclosure and their advantages are best understood by referring to the detailed description that follows. It should be appreciated that like reference numerals are used to identify like elements illustrated in one or more of the figures, wherein showings therein are for purposes of illustrating examples of the present disclosure and not for purposes of limiting the same.

### DETAILED DESCRIPTION

Disclosed herein is a feed mixer assembly having a feed mixer platform on which is mounted a hopper with an auger assembly at least partially in the hopper and rotatably mounted relative to the platform. A main gearbox assembly has an output shaft coupled to the auger and an input shaft coupled to a first axial flux electric motor assembly. The first axial flux electric motor is controlled by a first inverter mounted on the platform and electrically coupled to the first axial flux electric motor assembly. An electric battery assembly is also mounted on the platform and electrically coupled to the first inverter. A control gearbox assembly is also mounted on the platform and has a three-way gearbox disposed to transfer power between a first driveshaft extending along a first axis, a second driveshaft, and a third driveshaft, where the first driveshaft is an input shaft and the second driveshaft is an output shaft coupled to a pump mounted on the platform. A second axial flux electric motor assembly is mounted on the platform and coupled to the third driveshaft of the control gearbox assembly where the second axial flux electric motor may alternatively be used to drive the pump or generate electricity for storage by the electric batter assembly utilized to power the first axial flux motor and the auger.

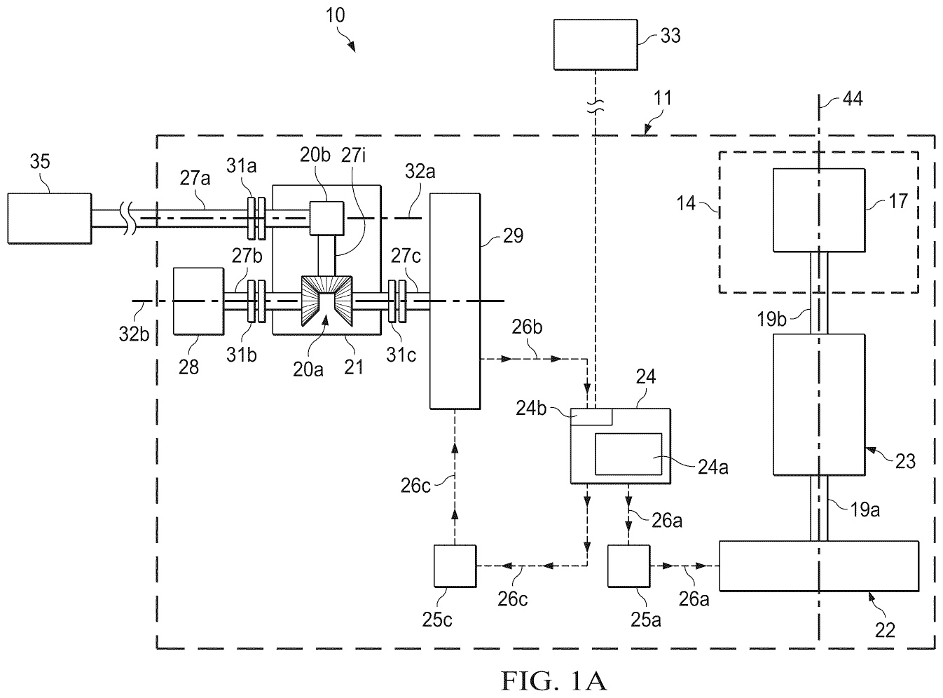

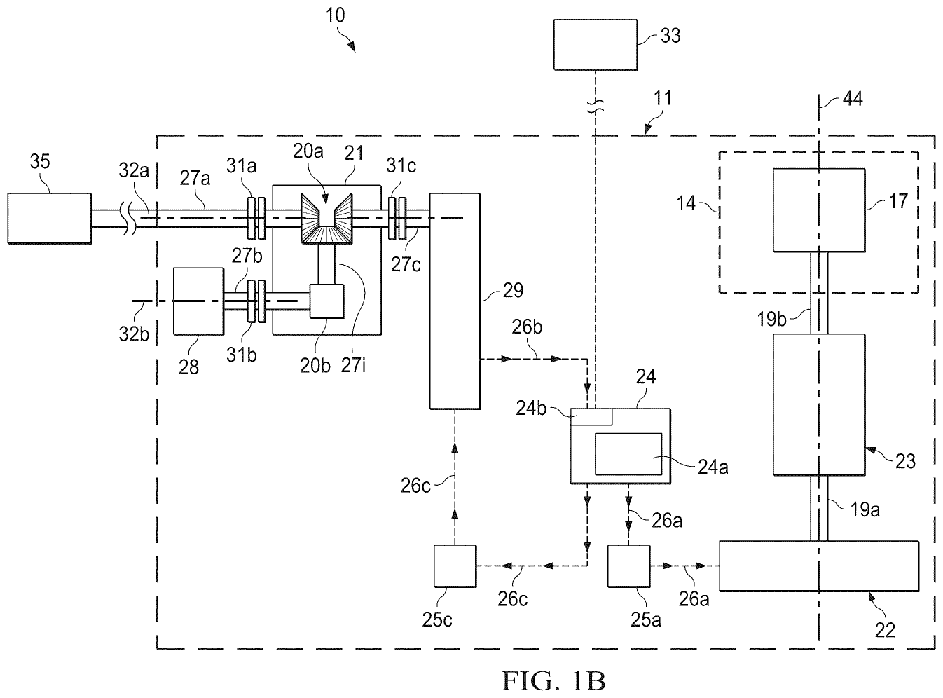

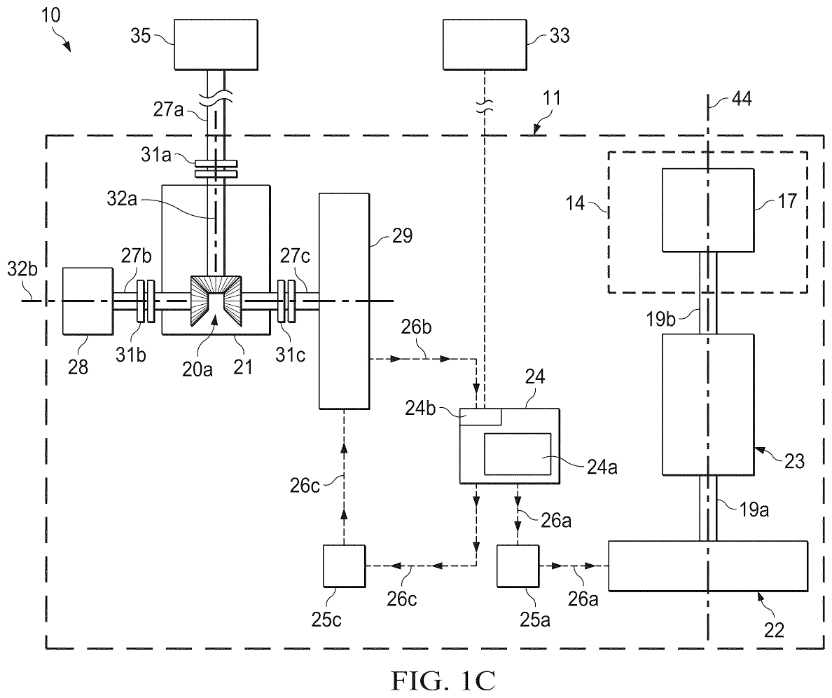

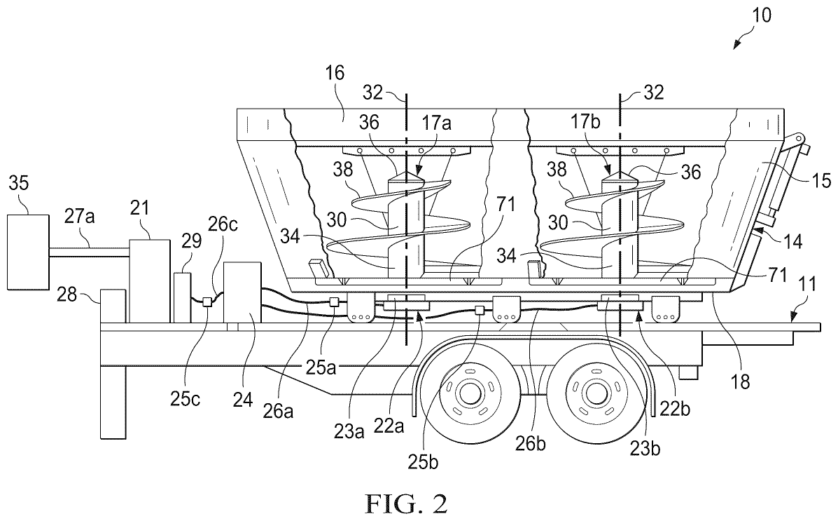

With reference to FIGS. 1a and 2, disclosed herein is an electric feed mixer assembly 10 having a feed mixer platform 11 on which a vessel or container 14 is mounted. A least one, and in some embodiments, two or more, auger assemblies 17 are mounted on the platform 11 and extend within the vessel 14. A main gearbox assembly 23 having an input shaft 19a and an output shaft 19b drives the auger assembly 17 via the output shaft 19b of the main gear assembly 23. A first electric motor 22, in turn, is coupled to the input shaft 19a of the main gearbox assembly 23. While first electric motor 22 is not limited to a particular type of electric motor, in some embodiments, the first electric motor 22 is an axial flux electric motor, while in other embodiments, first electric motor 22 is a radial flux electric motor. In some embodiments, because of the limited space on platform 11, an axial flux electric motor is preferred over a radial flux electric motor because of the shorter relative length of the axial flux electric motor having the same power production capabilities. The first electric motor 22 is in electrical communication, via cabling 26a, to an electric battery assembly 24 mounted on-board the platform 11 and utilizes an inverter 25a to manage electricity from the electric battery assembly 24 to the first electric motor 22 as indicated by the arrows along cabling 26a.

In one or more embodiments, the auger assembly 17 is a feed mixing auger. In one or more embodiments, the auger assembly 17 is a conveyor auger. In some embodiments, vessel 14 is a feed hopper. In other embodiments, vessel 14 may be an elongated conveyor housing.

In addition, electric feed mixer assembly 10 includes a control gearbox assembly 21 mounted on the platform 11. Control gearbox assembly 21 includes a first driveshaft 27a extending along a first axis 32a, a second driveshaft 27b, and a third driveshaft 27c, wherein the first driveshaft 27a is an input shaft coupled to an external power source 35 and the second driveshaft 27b is an output shaft. As will be discussed, third driveshaft 27c may function as either an input driveshaft or an output driveshaft. In any event, at least one of the second drive shaft 27b or third drive shaft 27c extends along a second axis 32b. While the disclosure is not limited to a particular orientation of second axis 32b to first axis 32a, in one or more embodiments as shown in FIG. 1a, second axis 32b may be parallel with first axis 32a. In one or more embodiments, as shown in FIG. 1c, second axis 32b may be perpendicular to first axis 32a.

Control gearbox assembly 21 includes a first gear assembly 20a to transfer power between first driveshaft 27a, second driveshaft 27b, and third driveshaft 27c, which first gear assembly 20a is a three-way gearbox. Depending on the physical arrangement of first drive shaft 27a, second drive shaft 27b, and third drive shaft 27c relative to one another, first gear assembly 20a may be positioned along either first axis 32a or the second axis 32b to mesh the driveshafts to one another. Likewise, depending on the physical arrangement of first drive shaft 27a, second drive shaft 27b, and third drive shaft 27c relative to one another, control gearbox assembly 21 May also include an intermediate driveshaft 27i as shown in FIGS. 1a and 1b. In any event, first gear assembly 20a interconnects at least three of the aforementioned driveshafts with one another to transfer power between said driveshafts.

Optionally, control gearbox assembly 21 may further include at least one second gear assembly 20b as shown in FIGS. 1a and 1b. It will be appreciated that the number and type of second gear assemblies 20b utilized in control gearbox assembly 21 may vary depending on the physical relationship of the first driveshaft 27a, second driveshaft 27b, and third driveshaft 27c so long as the various operating modes as described below can be achieved. For example, in some embodiments such as is shown in FIG. 1, second driveshaft 27b and third driveshaft 27c may extend along a second axis 32a that is parallel with first axis 32a. In such case, second gear assembly 20b is a right-angle gearbox to deliver power to first gear assembly 20a. Where first axis 32a is perpendicular with second axis 32b, second gear assembly 20b may be eliminated, as shown in FIG. 1c. In such an arrangement, first gear assembly 20a is positioned along the second axis 32b as well as first axis 32a.

In yet other embodiments, one of the second driveshaft 27b or third driveshaft 27c may be disposed along the first axis 32a, in which case first gear assembly 20a is positioned along first axis 32a and second gear assembly 20b may either be a right-angle gearbox as shown in FIG. 1b or eliminated altogether if second axis 32b is perpendicular to the first axis 32a as shown in FIG. 1c.

Electric feed mixer assembly 10 includes one or more pumps 28 mounted on the platform 11 and coupled to the second driveshaft 27b of the control gearbox assembly 21.

Electric feed mixer assembly 10 includes a charging electric motor assembly 29 mounted on the platform 11 and coupled to the third driveshaft 27c of the control gearbox assembly 21.

The charging electric motor assembly 29 is in electrical communication, via electric cabling 26b, with the electric battery assembly 24 to charge electric battery assembly 24, as indicated by the arrows along cabling 26b, when the charging electric motor assembly 29 is in a first mode or configuration. The charging electric motor assembly 29 may also be in electrical communication with electric battery assembly 24 via an inverter 25c and cabling 26c, as indicated by the arrows along cabling 26c, so that the electric battery assembly 24 can drive the charging electric motor assembly 29 when the charging electric motor assembly 29 is in a second mode or configuration disposed to provide power to pump 28. In one or more embodiments, charging electric motor assembly 29 is an axial flux electric motor. While charging electric motor 29 is not limited to a particular type of electric motor, in some embodiments, the charging electric motor 29 is an axial flux electric motor, while in other embodiments, charging electric motor 29 is a radial flux electric motor. Again, due to the limited space on platform 11, an electric motor with a shorter axial length, namely the axial flux electric motor, may be particularly desirable. Moreover, axial flux electric motors are more readily suited for the dual purpose of generation of electricity as described below.

External power source 35 may be selectively engaged and disengaged with first driveshaft 27a. In one or more embodiments, the external power source 35 is separate from the feed mixer platform 11. For example, external power source 35 may be a tractor with a power take-off that is coupled to the first driveshaft 27a but that can be decoupled and removed as desired. In other embodiments, the external power source 35 may be an internal combustion engine which may be mounted on platform 11 or separate from platform 11.

One or more engagement mechanisms 31 may be utilized to couple first driveshaft 27a, second driveshaft 27b and third driveshaft 27c, as well as their respective external power source 35, pump(s) 28 and charging electric motor assembly 29, together in order to achieve a particular operating condition. Engagement mechanisms 31 may include, but are not limited to clutches, clutch plates, shift mechanism or other devices to selectively engage and disengage driveshafts and/or the components coupled thereto.

In one or more embodiments, the second and third driveshafts 27b, 27c are coupled together, while in other embodiments, the second and third driveshafts 27b, 27c may be selectively coupled and decoupled utilizing one or more engagement mechanisms 31b, 31c, such as a clutch. Likewise, in one or more embodiments, the first and third driveshafts 27a, 27c are coupled together, while in other embodiments, the first and third driveshafts 27a, 27c may be selectively coupled and decoupled utilizing one or more engagement mechanism 31a, 31c. In some embodiments, the control gearbox assembly 21 may include an engagement mechanism 31a to selectively couple the first driveshaft 27a to the third driveshaft 27c and a second engagement mechanism 31b to selectively couple the second driveshaft 27b to the third driveshaft 27c. Any one of the engagement mechanisms 31 utilized in the electric feed mixer may be an electric clutch, a hydraulic clutch or pneumatic clutch.

The electric battery assembly 24 may include one or more batteries 24a and a charging module 24b to manage electricity supplied from an external electricity source 33 or the charging axial flux electric motor assembly 29, as desired. The external electricity source 33 is an electricity source remote from the feed mixer platform 11, such as an electric power grid, wind turbine or solar panel assembly.

Electric cabling 26 electrically couples the electric battery assembly 24 to the charging axial flux electric motor assembly 29 and may be utilized to deliver electricity i) from the charging axial flux electric motor assembly 29 to the electric battery assembly 24 in order to charge the electric battery thereof (as shown, electric cabling 26b), or ii) from the electric battery assembly 24 to the charging axial flux electric motor assembly 29 to drive the charging axial flux electric motor assembly 29 in order to power the pump 28 (as shown, electric cabling 26c).

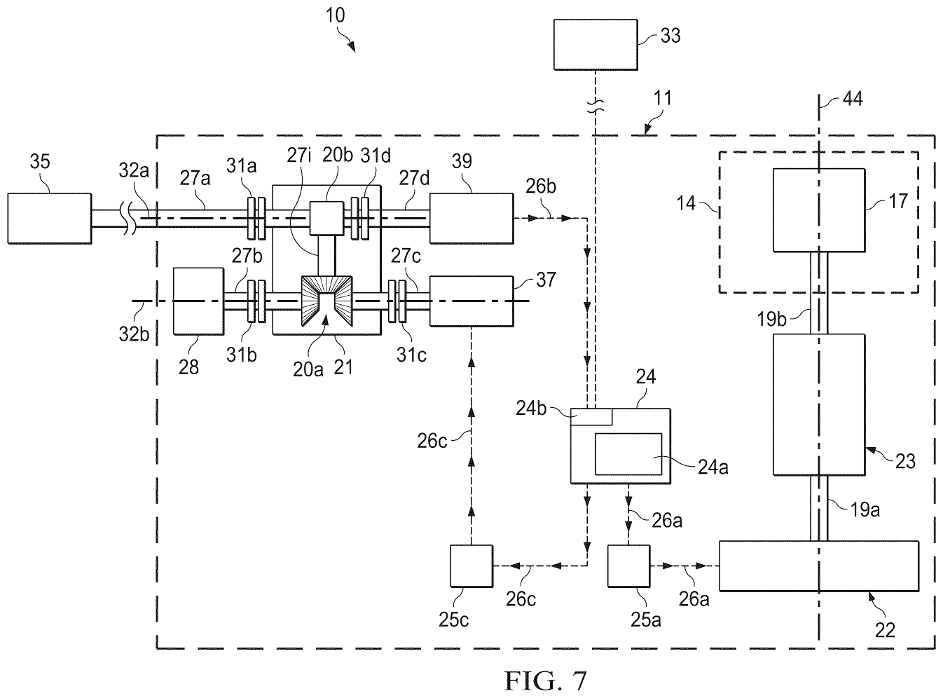

In one or more embodiments, the charging axial flux electric motor assembly 29 utilized to both charge the electric battery assembly 24 and provide power to the pump 28, may be replaced by a second electric motor 37 and a separate electric generator 39 (see FIG. 7). In such case, the external power source 35 may be utilized to selectively drive the electric generator 39 to produce electricity to charge the electric battery assembly 24, or to drive the pump 28, or to provide power to both the electric generator 39 and the pump 28 simultaneously. Engagement mechanisms 31a, 31b may be utilized to selectively control such operations. In such case, when the electric battery assembly 24 is utilized to operate the second electric motor 37, the second driveshaft 27b may be disengaged from the first driveshaft 27a.

In one or more embodiments, the pump 28 is an oil pump or hydraulic pump. The pump 28 may be utilized to lubricate or operate various equipment on the platform. For example, the pump may be utilized to control or cool the main gearbox assembly 23.

In one or more embodiments, at least two auger assemblies 17 are provided. In some embodiments, the one or more auger assemblies 17 may each be vertically oriented and extend up from a hopper base, the auger assembly being rotatably mounted relative to the base. Where two or more auger assemblies are provided, each may include a main gearbox assembly 23a, 23b and each may be driven by a separate electric motor assembly 22. Each separate electric motor assembly 22 may be controlled by a separate inverter 25. In one or more embodiments, the auger assembly 17 is vertically oriented relative to platform 11. In one or more embodiments, the auger assembly 17 is horizontally oriented relative to platform 11. In yet other embodiments, particularly where auger assembly 17 is a conveyor auger, the auger assembly 17 may be angled relative to platform 11

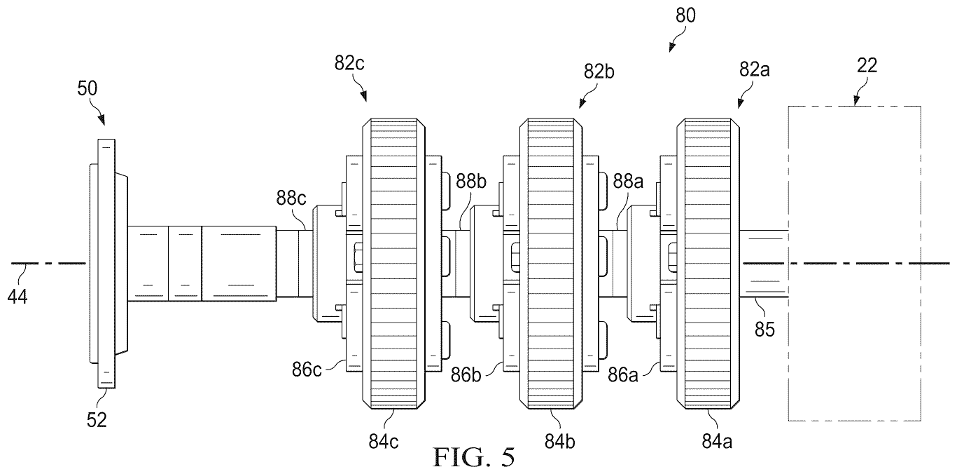

In one or more embodiments, the main gearbox assembly 23 may include a planetary reduction gear train assembly 80 (see FIG. 5) disposed along a main gearbox axis 44, wherein the driveshaft of the first electric motor 22 is disposed along the main gearbox axis 44.

In one or more embodiments, the platform 11 is a skid. In one or more embodiments, the platform 11 is a wheeled trailer.

While charging electric motor assembly 29 is described as an axial flux electric motor in some embodiments, in other embodiments, charging electric motor assembly 29 may be other types of electrical motors with the capability of producing electricity when operated in a first mode as an electric alternator, and producing power when operated in a second mode as an electric motor.

An electric feed mixer assembly 10 is illustrated. The feed mixer assembly may be mounted on the platform 11. Platform 11 may be a trailer chassis or skid or a stationary fixture. In any event, feed mixer assembly 10 generally includes a vessel or hopper 14 formed of a hopper wall 15 forming an opening 16 at the top of hopper 14 into which feed may be charged. Hopper 14 further includes a base 18 from which at least one vertically arranged auger assembly 17 extends. In the illustrated embodiment, two auger assemblies 17a, 17b are shown vertically extending from hopper base 18. Mounted below each auger assembly 17 is a first electric motor assembly 22 and main gearbox assembly 23. In some embodiments, the main gearbox assembly 23 is mounted to hopper base 18. In any event, it will be appreciated that each first electric motor assembly 22 is independent of the other first electric motor assembly 22. Moreover, neither first electric motor assembly 22 is mechanically driven, such as would be the case of prior art feed mixers driven by a PTO from a tractor. Rather, an electric battery assembly 24 is utilized to supply electricity to each first electric motor assembly 22 via cables 26a and 26b. Each electric cable 26a, 26b extends to a separate inverter 25a, 25b for controlling the first electric motor assembly 22a, 22b. In other embodiments, the one or more first electric motor assemblies 22 may be controlled by a single inverter 25a.

In any event, auger assembly 17 includes an auger shaft 30 extending along a main gearbox axis 44 and having a proximal end 34 adjacent the base 18 of hopper 14 and a distal end 36 extending toward opening 16 of hopper 14. Auger shaft 30 may be tapered, decreasing in diameter from the proximal end 34 to the distal end 36. At least one auger blade 38 extends from auger shaft 30. In some embodiments such as is shown, auger blade 38 may be a helical blade extending along at least a portion of the length of auger shaft 30. Likewise, as shown, in some embodiments, auger blade 38 my increase in its outer diameter along the length of auger shaft 30, such that blade 38 has a smaller diameter adjacent the distal end 36 of auger shaft 30 and a larger diameter adjacent the proximal end 34 of auger shaft 30.

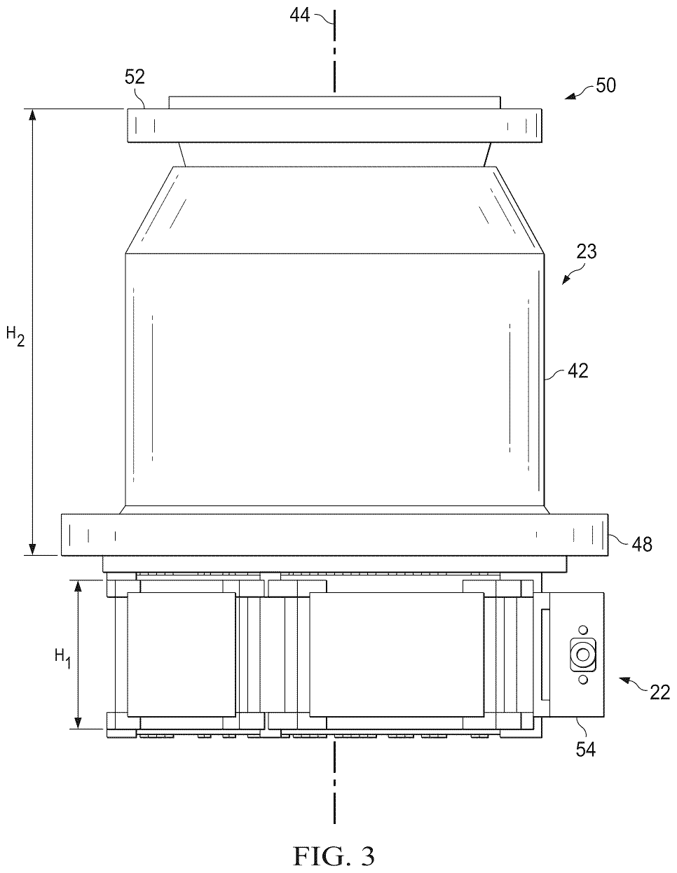

In FIG. 3, one embodiment of a main gearbox assembly 23 is illustrated in more detail. Specifically, in this embodiment, main gearbox assembly 23 includes a gearbox housing 42 generally disposed along a main gearbox axis 44 with an axial flux electric motor assembly 22 coupled to main gearbox assembly 23 adjacent a first end 48 of gearbox housing 42. main gearbox assembly 23 includes a hub 50 that is rotatable relative to gearbox housing 42. A flange 52 may be provided at a distal end of hub 50 for securing hub 50 to the proximal end 34 of an auger shaft 30 (see FIG. 2).

As is clear from the figures and for the reasons discussed below, motor housing 54 of axial flux electric motor assembly 46 has a relatively low profile, as indicated by axial length H1, compared to the axial length H2 of main gearbox assembly 23 along main gearbox axis 44.

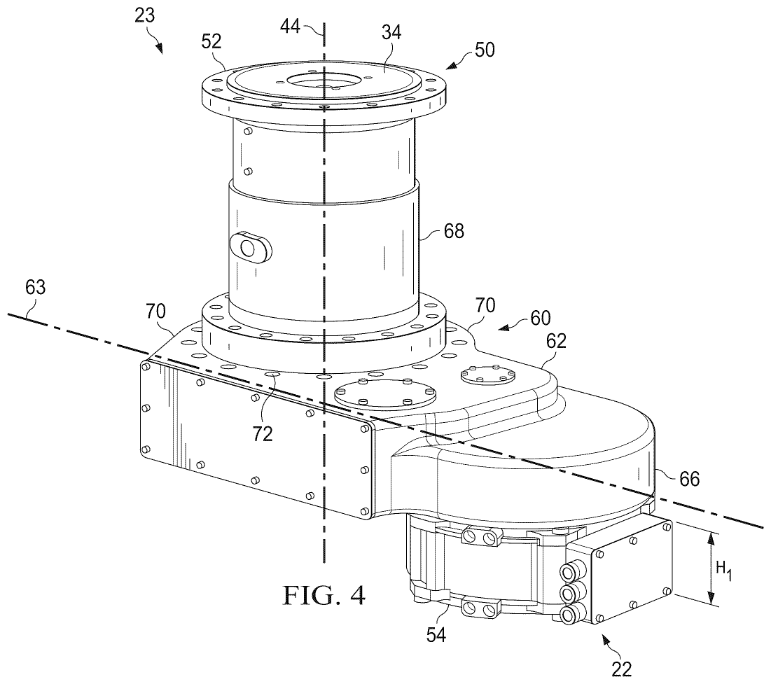

In FIG. 4, another embodiment of an main gearbox assembly 23 is illustrated in more detail. Specifically, in this embodiment, main gearbox assembly 23 includes a first gearbox housing 62 generally disposed along a gearbox axis 63 with an axial flux electric motor assembly 22 attached to reduction gearbox assembly 60 adjacent a first end 66 of first gearbox housing 62 and a second gearbox housing 68 generally disposed along main gearbox axis 44 and attached to first gearbox housing 62 adjacent a second end 70 of first gearbox housing 62. main gearbox assembly 23 includes a hub 50 that is rotatable relative to second gearbox housing 68. A flange 52 may be provided at a distal end of hub 50 for securing hub 50 to the proximal end 34 of an auger shaft 30 (see FIG. 2).

Turning to FIG. 5, reduction gear train assembly 80 of main gearbox assembly 23 of FIG. 1 is illustrated. Reduction gear train assembly 80 is generally mounted within gearbox housing 42 (see FIG. 3) to transfer rotary motion from axial flux electric motor assembly 22 (illustrated in dashed lines) to hub 50. Reduction gear train assembly 80 includes at least one planetary gear set assembly 82, but preferably reduction gear train assembly 80 is multi-stage having two or more planetary gear assemblies 82. In the illustrated embodiment, a three gear set assemblies 82 are illustrated as first, second and third planetary gear set assembly 82a, 82b, 82c, respectively.

Each planetary gear set assembly 82a, 82b, 82c generally includes a ring gear 84 within which is meshed two or more planetary gears (not shown) mounted on a carrier 86, with an output shaft 88 extending along main gearbox axis 44. A sun gear (not shown) is mounted on input shaft 85, also extending along main gearbox axis 44, driven by axial flux electric motor assembly 46 and meshes with the planetary gears (not shown) of the first planetary gear set assembly 82a in a manner well known in the art. Each carrier 86 includes an output shaft 88. The first output shaft 88a and the second output shaft 88b each include a sun gear (not shown), while the third output shaft 88c engages hub 50 or otherwise comprises hub 50 such that rotation of third carrier 86c rotates hub 50 and flange 52 relative to gearbox housing 42. In one or more embodiments, one or more of ring gears 84a, 84b, 84c are integrally formed as part of gearbox housing 42.

In one or more embodiments, the reduction of at least one of the first planetary gear set assembly 82a, the second planetary gear set assembly 82b and the third planetary gear set assembly 82c ranges from 5:1 to 6:1, while in other embodiments, two or more planetary gear set assemblies 82 have a reduction in the range of 5:1 to 6:1. In one or more embodiments, the reduction of at least one of the first planetary gear set assembly 82a, the second planetary gear set assembly 82b and the third planetary gear set assembly 82c is approximately 5.2:1.

In one or more embodiments, the reduction of planetary gear set assembly 82 ranges from 5:1 to 6:1. In one or more embodiments, the reduction of planetary gear set assembly 82 is approximately 5.2:1.

In one or more embodiments, the total reduction of reduction gear train assembly 80 having one or more planetary gear set assemblies 82 ranges from 154:1 to 150:1. In one or more embodiments, the total reduction of reduction gear train assembly 80 having one or more planetary gear set assemblies 82 is approximately 152.8:1.

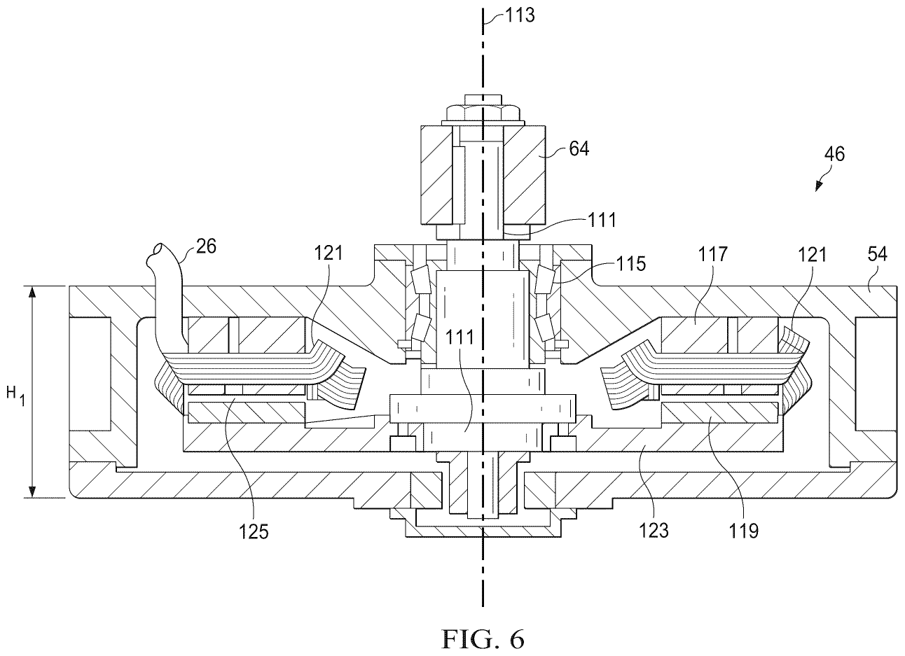

Turning to FIG. 6, axial flux electric motor assembly 22 is generally illustrated and includes a motor housing 54 in which a driveshaft 111 is supported on bearing 115. Driveshaft 111 extends along a axis 113 and includes a first gear 64 mounted on driveshaft 111. Mounted on driveshaft 111 is at least one rotor 123. Spaced apart from the rotor 123 along the axis 113 is at least one stator 117, thereby forming a gap 125 therebetween. Rotor 123 may include magnets 119 placed about a circumference of the rotor 123. Stator 117 may include windings 121 positioned about a circumference of the stator 117 and electrically communicating with cable 26. In some embodiments, stator 117 may be fixed to the motor housing 54. The disclosure is not limited to a particular arrangement of axial flux electric motor, and in particular, the disclosure is not limited to a particular arrangement of rotors and stators. However, it will be appreciated that the axial flux electric motor assembly 46 has a generally narrow profile that permits it to be installed within limited confines, such as below a hopper 14 carried on a truck chassis 11 (see FIG. 1). Moreover, it will be appreciated that as desired to increase power or torque output of the axial flux electric motor assembly 46, the overall profile H1 need not be significantly changed. Rather, the rotor 123 and stator 117 may be adjusted, such as by increasing the respective diameters of the rotor 123 and stator 117. In other words, increasing the rotor 123 and stator 117 diameters in order to achieve the desired power or torque for a particular feed mixing application need not result in a change in the low-profile characteristic of the overall axial flux electric motor assembly 46.

In one or more embodiments, driveshaft 111 is the same as or otherwise coupled to input shaft 85 of reduction gear train assembly 80 or to input shaft 106 of reduction gear train assembly 100, in which case first gear 64 is the first sun gear 83a of reduction gear train assembly 80 or the first gear 110 of reduction gear train assembly 100, respectively.

FIG. 7 is similar to FIG. 1, but replaces the charging axial flux electric motor assembly 29 coupled to third driveshaft 27c with second electric motor 37 coupled to third driveshaft 27c and separately, an electric generator 39 coupled to a fourth driveshaft 27d. In one embodiment, an engagement mechanism 31b, such as a clutch, is utilized to selectively engage and disengage fourth driveshaft 27d and first driveshaft 27a, and an engagement mechanism 31a, such as clutch, is utilized to selectively engage and disengage second driveshaft 27b and first driveshaft 27a.

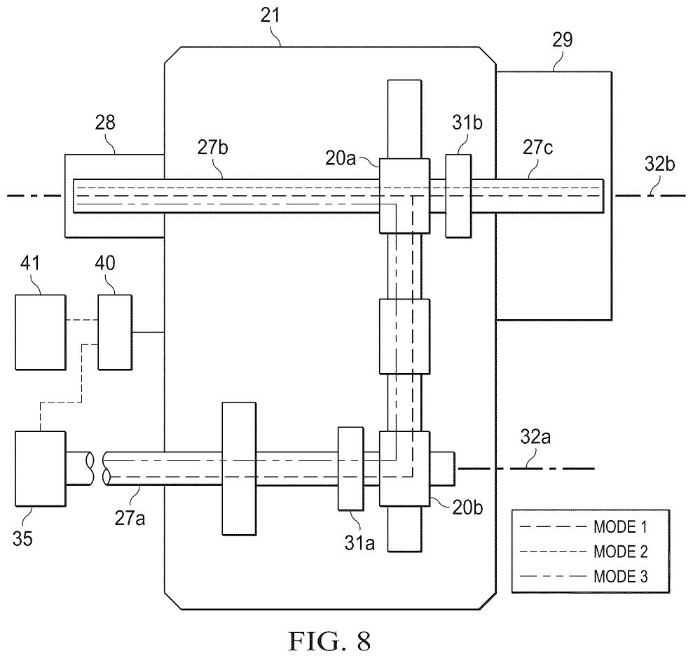

FIG. 8 illustrates one embodiment of operation of control gearbox assembly 21 with respect to pump 28 and charging electric motor assembly 29, and in particular, various modes of operation of electric feed mixer assembly 10.

In mode 1, first clutch 31a and second clutch 31b are both closed or otherwise engaged so that input from external power source 35 provided via driveshaft 27a operates both pump 28 and charging electric motor assembly 29. Notably, in this first mode, charging electric motor assembly 29 is in a first mode and produces electricity to charge electric battery assembly 24. Mode 1 may be useable when it is desirable to increase a level of charge of the electric battery assembly 24, among other scenarios. The external power source 35 provides power to the charging electric motor assembly 29 to charge the electric batter assembly 24 while simultaneously providing power to the pump 28 for operation of pump 28. This allows the pump 28 to perform functions such as lubricating, operating, controlling, or cooling various components within the electric feed mixer 10, while the level of charge in the electric battery assembly 24 is increased.

Mode 1 provides a plurality of advantages. For example, when the power requirements of the pump 28 are less than the power being supplied by the external power source 35, using the excess power to enable the charging electric motor assembly 29 to produce electricity (and thereby charge the electric battery assembly 24) optimizes energy usage and consumption. The excess power that, without the capabilities provided by mode 1, may have otherwise not been utilized, is stored in the electric battery assembly 24 for future or different uses. In this way, among other ways, this disclosure increases energy efficiency, versatility, and power distribution of electric feed mixers.

In mode 2, first clutch 31a is closed or otherwise engaged while second clutch 31b is open or otherwise disengaged so that external power source 35 provided via driveshaft 27a operates only pump 28 via driveshaft 27b. In this embodiment, charging electric motor assembly 29 is disengaged from operation and does not receive power, and therefore, the charge of the electric battery assembly 24 does not increase. Mode 2 may be used when it is not desirable to charge of the electric battery assembly 24, when the level of charge of the electric battery assembly 24 is already at a sufficient level, or when the power requirements of the pump 28 are best suited by the external power source 35 alone, among other scenarios. For example, when access to the external power source 35 is available it may be desirable to direct all of the power from the power source 35 directly to the pump 28. That way, power stored in the electric battery assembly 24 may be stored and utilized at a later time when access to the external power source 35 is no longer available.

Mode 2 provides a plurality of advantages. By opening (e.g., disengaging) the electric motor assembly 29, power loss through the driveshaft 27c is minimized, thereby increasing the overall efficiency of the electric feed mixer 10. Additionally, directing all of the power to the pump 28 may increase the consistency at which power is provided to pump 28 while decreasing fluctuations in the power supply. Furthermore, mode 2 allows for greater versatility, since it is undesirable to use the power from the electric battery assembly 24 in some situations.

Finally, in mode 3, first clutch 31a is open or otherwise disengaged and second clutch 31b is closed or otherwise engaged, allowing charging electric motor assembly 29 to operate in its second mode to provide driving power via third driveshaft 27c to pump 28. Mode 3 may be useable when the charging electric motor assembly 29 has a level of charge sufficient to power the pump 28, among other scenarios. In some examples, mode 3 is used when the external power source 35 is no longer accessible or is no longer providing any power. Because the first clutch 31a is disengaged, power flows from the charging electric motor assembly 29 to the pump 28 and not to the external power source 35. In this way, the charging electric motor assembly 29 may be the sole source of power for the pump 28 in the mode 3.

Mode 3 provides a plurality of advantages. By relying on the electric battery assembly 24 and the charging electric motor assembly 29 as the source of power, the external power source is not required. This allows the electric feed mixer to be pulled by things such as smaller vehicles, livestock, and other man-powered apparatuses, as they do not simultaneously have to be a source of power. Mode 3 allows for quiet and clean use of the electric feed mixer assembly 10. Because the power is provided by an electric source, the use of the feed mixer produces much less noise and is does not put any pollutants into the atmosphere. In this way, the electric feed mixer 10 does not disrupt people or animals nearby, and does not contaminate the environment when being used near cities, houses, or other places where people and animals dwell.

The control gearbox assembly 21 may switch between modes 1, 2, and 3 automatically depending on the sensed circumstance or at the direction of an operator. The control gearbox assembly 21 being operable in a plurality of modes such as modes 1, 2, and/or 3 to provide many advantages such as reducing emissions, lower operating costs, decreasing noise produced by feed mixers, decreasing pollution, and enhancing durability.

A controller 40 may be utilized to monitor feed mixer assembly 10 and change between modes in order to control power distribution.

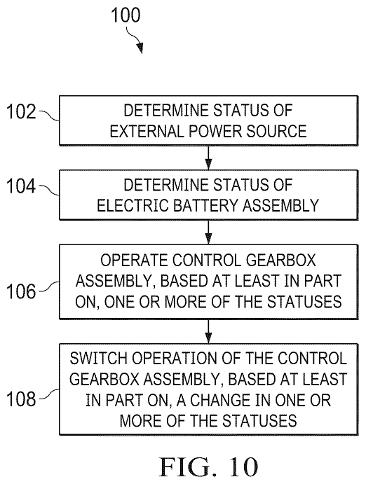

With reference to FIG. 10, a process 100 is provided for controlling power distribution for the feed mixer assembly 10. Steps in the process 100 may be implemented using controller 40 and/or a non-transitory computer readable medium storing instructions executable by a process. The controller 40 may be part of or connected to the control gearbox assembly 21. The controller 40 may be in physical or wireless communication with the components of the feed mixer assembly 10. As shown in FIG. 8, the controller 40 may be in physical communication with the control gearbox assembly 21 and wireless communication with the external power source 35 and a remote device 41. In other examples, the controller 40 is in physical communication with the external power source 35 and wireless communication with the control gearbox assembly 21.

In any event, in a first step 102, a status of the external power source 35 is determined. For example, the controller 40 may determine whether the external power source 35 is engaged with the first driveshaft 27a. By determining whether the external power source 35 is present and engaged, the controller 40 understands whether the external power source 35 would be capable of transmitting power to the pump 28 and/or the charging electric motor assembly 29 if modes 1 or 3 described above are implemented. In other examples, determining the status of the external power source 35 may include determining whether the external power source 35 is providing power through the driveshaft 27a or the amount of time before the power provided through the external power source 35 runs out or otherwise ends.

In step 104, a status of the electric battery assembly 24 is determined. For example, the controller 40 may determine a level of charge of the electric battery assembly 24. If the electric battery assembly 24 has received no charge or is fully drained, the electric battery assembly 24 and the charging electric motor assembly 29 are (a) incapable of transmitting power to the pump 28 and (b) capable of absorbing power supplied by the external power source 35. If the electric battery assembly 24 is partially charged, then the electric battery assembly 24 and the charging electric motor assembly 29 are (a) capable of transmitting power to the pump 28 and (b) capable of absorbing power supplied by the external power source 35. If the electric battery assembly 24 is fully charged, then the electric battery assembly 24 and the charging electric motor assembly 29 are (a) capable of transmitting power to the pump 28 and (b) incapable of absorbing power supplied by the external power source 35.

Understanding these capabilities can dictate or aid the controller 40 and/or operator to select the appropriate mode for the control gearbox assembly 21 to operate in. Determining the status of the electric battery assembly 24 may include other things as well such as determining whether the electric batter assembly and charging electric motor assembly 29 are operable, the rate at which the electric battery assembly 24 is being charged by other power sources (e.g., solar, wind, noise, etc.).

At step 106 control gearbox 21 is operated in mode 1, mode 2, or mode 3, based at least in part on, one or more of the statuses of the external power source 35 and the electric battery assembly 24. The controller 40 may be pre-programmed to automatically select an operating mode based on the current statuses. In other situations, an operator can interact with a user interface to select criteria and thresholds that must be met before the mode is selected.

In some examples, the control gearbox assembly 21 operates in mode 1 based on a determination that the external power source 35 is connected and the level of charge of the electric battery assembly 24 is less than 100 percent. In this way, the pump 28 will be supplied with power and the electric battery assembly 24 will be charged simultaneously. Knowledge that the external power source 35 will soon be disconnected or will soon run out of power may also encourage operation in mode 1. This way, the charging electric motor assembly 29 will be capable of powering the pump 28 immediately after or at some point in time after the external power source 35 is no longer providing power.

In some examples, the control gearbox assembly 21 operates in mode 2 based on a determination that the external power source 35 is connected to the first driveshaft 27a and/or that the electric battery assembly 24 is fully charged. In mode 2, the external power source 35 is solely relied upon. In some examples, the external power source 35 is relied upon to preserve the energy stored in the electric battery assembly 24. Other reasons for operation in mode 2 are fully understood, as previously discussed and as would occur to one of ordinary skill in the art. For example, the charging electric motor assembly 29 and the electric battery assembly 24 may be inoperable or the electric feed mixer 10 may be a location where use of the external power source 35 is permitted.

In some examples, the control gearbox assembly 21 operates in mode 3 based on a determination that the external power source 35 is disconnected and/or that the electric battery assembly 24 is above a threshold level of charge. The threshold level of charge may be any value. For example, it may require that the electric battery assembly 24 has a level of charge above zero percent so that at least some power would be supplied to the pump 28. In other examples, the electric battery assembly 24 may need to be above a threshold level to ensure that the electric feed mixer 10 would be operable based on the power from the electric batter assembly 24 for a long enough period of time before the stored and portable energy runs out.

Many variables, separate from the statuses of the external power source 35 and the electric batter assembly 24 may impact the mode that is selected. For example, mode 1 may be used when the power requirements of the pump 28 are below the power level being provided by the external power source. Or, mode 1 may be used when it is understood that additional sources of power such as wind and solar are not providing enough charge to the electric battery assembly 24. Mode 2 may be selected to power the pump 28 directly with the external power source 35, regardless of the level of charge of the charging electric motor assembly 29. In one embodiment, mode 2 is used when the power requirements of the pump 28 are better served by the external power source 35. Or, mode 2 may be used when it is sensed that the electric feed mixer 10 is located in where use of the external power source 35 is permitted or that it is a time of day where additional noise created by the external power source 35 would not be disruptive. In one embodiment, mode 3 may be used when the power requirements of the pump 28 are better served by the charging electric motor assembly 29. Or, mode 3 may be used when sensors such as GPS sensors or other types of sensors sense that the electric feed mixer 10 has entered into a location where use of the external power source 35 is not permitted. Or, mode 3 may be used based on a time of day such as in the early morning or late at night to prevent the creation of excess noise.

It is fully understood that the mode/configuration/operating mode of the control gearbox assembly 21 can be manually chosen by an operator or automatically chosen based on sensed or predetermined variables, or semi-automatically determined based both on the operator and the autonomous capabilities of the controller 40. The operator may control the control gearbox assembly 21 onboard the electric feed mixer 10, from the remote device 41, from the external power source 35, or via a network connection, among other methods.

At step 108, the controller 40 may switch from one mode to another. The controller 40 may be fed continuous or incremental readings that cause the controller 40 to switch operation of the control gearbox assembly 21 among modes. For example, the controller 40 may be continuously or incrementally determine or receive variables such as: a level of charge of the charging electric motor assembly 29, power requirements of the pump 28, a connection status of the external power source 35, a time remaining until the charging electric motor assembly 29 is fully charged, a time remaining until the charging electric motor assembly 29 has no charge, a time remaining until the external power source 35 is disconnected, a power status of the external power source 35, a time remaining until the external power source 35 is out of power, a type of power of the external power source.

In one example, the controller is configured to switch from operation in mode 1 to operation in mode 2 when the level of charge of the charging electric motor assembly 29 reaches a threshold level of charge. After reaching full charge, the external power source 35 becomes the sole source of power until the stored power from the electric battery assembly 24 is needed. In one example, the controller is configured to switch from operation in mode 2 to operation in mode 3 when the stored power from the electric battery assembly 24 is needed. For example, when the external power source 35 is disconnected or when it is desirable to operate the electric feed mixer assembly 10 more quietly and/or more environmentally cleaner. In one example, the controller is configured to switch from operation in mode 3 to operation in mode 1 when the level of charge of the electric battery assembly 24 is lower than a threshold level of charge or when the external power source 35 is once again capable of supplying the power. In one example, the controller is configured to switch from operation in mode 2 to operation in mode 1 when the level of charge of the electric battery assembly 24 is lower than a threshold level of charge so that the power being reserved in the electric battery assembly 24 is replenished. In one example, the controller is configured to switch from operation in mode I to operation in mode 3 when the level of charge of the electric battery assembly 24 reaches or surpasses a threshold level of charge. These are a few of many examples of the causes for switching from operation among modes, and additional examples are fully contemplated as would be understood by one of skill in the art.

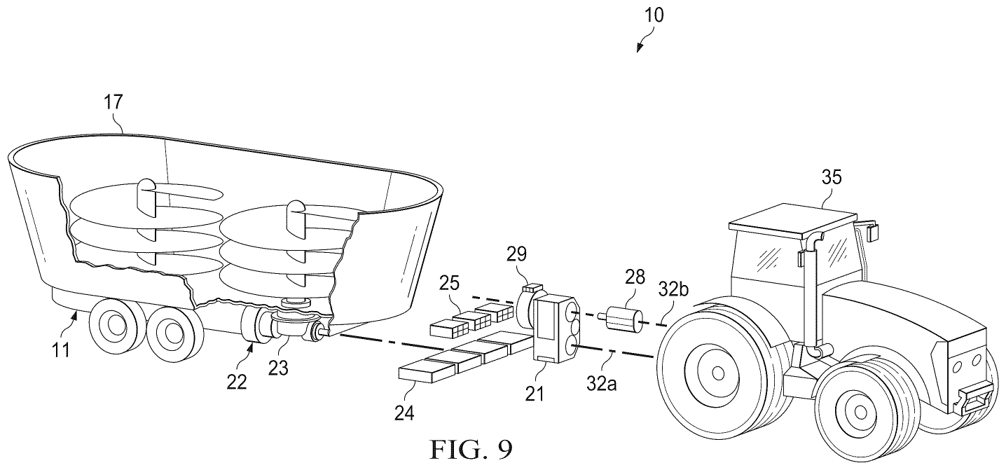

FIG. 9 is another illustration of one embodiment of electric feed mixer assembly 10. As shown, feed mixer assembly 10 includes a platform 11 on which an auger assembly 17 is mounted. A main gearbox assembly 23 drives the auger assembly 17. A first electric motor 22 provides power to main gearbox assembly 23. The first electric motor 22 is electrically coupled to an electric battery assembly 24 and utilizes inverters 25 to manage electricity from the electric battery assembly 24 to the first electric motor 22. Feed mixer assembly 10 also includes a control gearbox assembly 21. One or more pumps 28 are coupled to control gearbox assembly 21. Likewise, a charging electric motor assembly 29 is also coupled to control gearbox assembly 21. The charging electric motor assembly 29 is electrically connected to the electric battery assembly 24 to charge the battery when the charging electric motor assembly 29 is in a first mode or configuration. The charging electric motor assembly 29 is also electrically connected to the electric battery assembly 24 via an inverter 25 so that the electric battery assembly 24 can drive the charging electric motor assembly 29 when the charging electric motor assembly 29 is in a second mode or configuration. An external power source 35 is also coupled to control gearbox assembly 21 and serves a power input for control gearbox assembly 21. In the illustrated embodiment, external power source 35 is a tractor.

While the above-described system is most useful in agricultural applications for mixing feed for livestock, in other embodiments, an electric agricultural equipment assembly may be provided for other agricultural applications, such as an electric grain conveyor. In such case, the electric agricultural equipment assembly incudes a driven device, such as an auger assembly, powered by an electric motor, all supported on a platform. The electric motor powering the driven device is provided with electricity from the electric battery assembly on-board the platform utilizing an inverter to manage electricity from the battery to the electric motor. In addition, the platform includes a control gearbox assembly mounted on the platform and having a first driveshaft, a second drive shaft, and a third drive shaft, wherein the first driveshaft is an input shaft and the second driveshaft is an output shaft. As described above, a pump is mounted on the platform and coupled to the second driveshaft. A charging axial flux electric motor assembly is mounted on the platform and includes a driveshaft coupled to the third driveshaft of the control gearbox assembly. The charging axial flux electric motor is electrically connected to the electric battery assembly to charge the battery when the charging axial flux electric motor is in a first mode or configuration. The charging flux electric motor is also electrically connected to the electric battery assembly via an inverter so that the battery can drive the charging axial flux electric motor when the charging axial flux electric motor is in a second mode or configuration. In one or more embodiments, the second and third driveshafts are coupled together, while in other embodiments, the second and third driveshafts may be selectively coupled and decoupled utilizing a clutch mechanism. Likewise, in one or more embodiments, the first and third driveshafts are coupled together, while in other embodiments, the first and third driveshafts may be selectively coupled and decoupled utilizing a clutch mechanism.

In one or more embodiments, the auger assembly is an auger mixer. In one or more embodiments, the auger assembly is an auger conveyor. Where the auger assembly is an auger conveyor, the auger assembly may be at least partially supported on the platform. Where the auger assembly is an auger mixer, a mixing vessel, such as a hopper, may be at least partially supported on the platform.

In operation, the electric battery assembly 22 is charged via either external electricity source 33 or the charging axial flux electric motor assembly 29 (or electric generator 39) powered through the tractor. The pump 28 is driven for control or lubrication of control gearbox assembly 21, the main gearbox assembly 23, engagement mechanisms 31, and/or other equipment

When the electric battery assembly 22 is charged (via external electricity source 33 or the charging axial flux electric motor assembly 29) the system may be switch from operating the charging axial flux electric motor assembly 29 as an electric generator to operating the charging axial flux electric motor assembly 29 as a power source for the motor 28, thereby continuing to power the pump 28 for the services and lubrication. The capacity of the electric battery assembly 24 can be monitored and if the battery charge drops below a predetermined capacity, the external power source 35 may be implemented. The inverters control the motor phases for mixing and for discharging. Likewise, the inverters and clutches control the mixing and discharging phases by opening and closing clutches 31 of the control gearbox assembly 21 and changing rotation speeds.

Thus, a feed mixer assembly has been described. The feed mixer assembly may include a feed mixer platform; a hopper having a base and mounted on the platform; an auger assembly extending from the hopper base and rotatably mounted relative to the base; a main gearbox assembly having an input shaft and an output shaft, the output shaft coupled to the auger; a first axial flux electric motor assembly having a driveshaft coupled to the input shaft of the main gearbox assembly; a first inverter mounted on the platform and electrically coupled to the first axial flux electric motor assembly; an electric battery assembly mounted on the platform and electrically coupled to the first inverter; a control gearbox assembly mounted on the platform and having a first driveshaft extending along a first axis, a second driveshaft, and a third driveshaft, wherein the first driveshaft is an input shaft, and the second driveshaft is an output shaft; a pump mounted on the platform and coupled to the second driveshaft; a second axial flux electric motor assembly mounted on the platform, the second axial flux electric motor assembly coupled to the third driveshaft of the control gearbox assembly; and a second inverter mounted on the platform and electrically coupled between the second axial flux electric motor assembly and the battery.

The feed mixer assembly may include a feed mixer platform; a vessel supported on the platform; an auger assembly extending into the vessel and rotatably mounted relative to the platform; a main gearbox assembly having an input shaft and an output shaft, the output shaft coupled to the auger; a first electric motor assembly having a driveshaft coupled to the input shaft of the main gearbox assembly; a first inverter mounted on the platform and electrically coupled to the first electric motor assembly; an electric battery assembly mounted on the platform and electrically coupled to the first inverter; a control gearbox assembly mounted on the platform and having a first driveshaft extending along a first axis, a second driveshaft, and a third driveshaft, wherein the first driveshaft is an input shaft, and the second driveshaft is an output shaft; a pump mounted on the platform and coupled to the second driveshaft; a second electric motor assembly mounted on the platform, the second electric motor assembly coupled to the third driveshaft of the control gearbox assembly; and a second inverter mounted on the platform and electrically coupled between the second electric motor assembly and the battery.

The feed mixer assembly may include a feed mixer platform; a vessel supported on the platform; an auger assembly extending into the vessel and rotatably mounted relative to the platform; a main gearbox assembly having an input shaft and an output shaft, the output shaft coupled to the auger; a first electric motor assembly having a driveshaft coupled to the input shaft of the main gearbox assembly; a first inverter mounted on the platform and electrically coupled to the first electric motor assembly; an electric battery assembly mounted on the platform and electrically coupled to the first inverter; a control gearbox assembly mounted on the platform and having a first driveshaft extending along a first axis, a second driveshaft, and a third driveshaft, wherein the first driveshaft is an input shaft, and the second driveshaft is an output shaft; a pump mounted on the platform and coupled to the second driveshaft; a second electric motor assembly mounted on the platform, the second electric motor assembly coupled to the third driveshaft of the control gearbox assembly; a second inverter mounted on the platform and electrically coupled between the second electric motor assembly and the battery; and a first gear assembly, wherein the second and third driveshafts of the control gearbox assembly are aligned along a second axis with the first gearbox positioned along the second axis; and wherein the first gear assembly is a three-way gearbox.

The feed mixer assembly may include a feed mixer platform; a vessel supported on the platform; an auger assembly extending into the vessel and rotatably mounted relative to the platform; a main gearbox assembly having an input shaft and an output shaft, the output shaft coupled to the auger; a first electric motor assembly having a driveshaft coupled to the input shaft of the main gearbox assembly; a first inverter mounted on the platform and electrically coupled to the first electric motor assembly; an electric battery assembly mounted on the platform and electrically coupled to the first inverter; a control gearbox assembly mounted on the platform and having a first gear assembly, a first driveshaft, a second driveshaft, and a third driveshaft, wherein the first driveshaft is an input shaft and at least two of the first driveshaft, second driveshaft, and third driveshaft extend from the first gear assembly; a pump mounted on the platform and coupled to the second driveshaft; a second electric motor assembly mounted on the platform, the second electric motor assembly coupled to the third driveshaft of the control gearbox assembly; and a second inverter mounted on the platform and electrically coupled between the second electric motor assembly and the battery; wherein at least two of the first driveshaft, second driveshaft, and third driveshaft are aligned along the same axis, and where the first gear assembly is a three-way gearbox.

The feed mixer assembly may include a feed mixer platform; a hopper mounted on the platform; an auger assembly within the hopper and rotatably mounted relative to the hopper; a main gearbox assembly having an input shaft and an output shaft, the output shaft coupled to the auger; a first electric motor assembly having a driveshaft coupled to the input shaft of the main gearbox assembly; a first inverter mounted on the platform and electrically coupled to the first electric motor assembly; an electric battery mounted on the platform and electrically coupled to the first inverter; a control gearbox assembly mounted on the platform and having a first driveshaft, a second driveshaft, and a third driveshaft, wherein the first driveshaft is an input shaft and the second driveshaft is an output shaft; a pump mounted on the platform and coupled to the second driveshaft; a second electric motor assembly mounted on the platform, the second electric motor assembly having a driveshaft coupled to the third driveshaft of the control gearbox assembly; and a second inverter mounted on the platform and electrically coupled between the second electric motor assembly and the battery.

A farming assembly may include a platform; an auger assembly at least partially supported on the platform; a main gearbox assembly having an input shaft and an output shaft, the output shaft coupled to the auger assembly; a first electric motor assembly having a driveshaft coupled to the input shaft of the main gearbox assembly; a first inverter mounted on the platform and electrically coupled to the first electric motor assembly; an electric battery assembly mounted on the platform and electrically coupled to the first inverter; a control gearbox assembly mounted on the platform and having a first gear assembly, a first driveshaft, a second driveshaft, and a third driveshaft, wherein the first driveshaft is an input shaft and at least two of the first driveshaft, second driveshaft, and third driveshaft extend from the first gear assembly; a pump mounted on the platform and coupled to the second driveshaft; a second electric motor assembly mounted on the platform, the second electric motor assembly coupled to the third driveshaft of the control gearbox assembly; and a second inverter mounted on the platform and electrically coupled between the second electric motor assembly and the battery; wherein at least two of the first driveshaft, second driveshaft, and third driveshaft are aligned along the same axis, and where the first gear assembly is a three-way gearbox.

The foregoing assemblies may include any one or more of the following, alone or in combination with one another:
the control gearbox assembly comprises a first gearbox assembly, wherein the second and third driveshafts of the control gearbox assembly are aligned along a second axis with the first gearbox positioned along the second axis; and wherein the first gearbox assembly is a three-way gearbox.
the second and third driveshafts of the control gearbox assembly are selectively coupled together.
an external electricity source electrically coupled to the battery, wherein the external electricity source is a power grid.
a power source detachably coupled to the first driveshaft of the control gearbox, wherein the power source is an engine or the power take off of a tractor.
the pump is an oil pump or hydraulic pump.
the pump is in fluid communication with the main gearbox assembly.
at least two auger assemblies, each vertically extending from the hopper base and rotatably mounted relative to the base; at least two main gearbox assemblies, each having an input shaft and an output shaft, the output shaft coupled to an auger; at least two first axial flux electric motor assemblies, each having a driveshaft coupled to the input shaft of a separate main gearbox assembly; and a least two first inverters mounted on the platform, each electrically coupled to a separate one of the first axial flux electric motors.
the control gearbox assembly further comprises a first clutch to selectively couple the first driveshaft to the third driveshaft and a second clutch to selectively couple the second driveshaft to the third driveshaft.
the main gearbox assembly comprises a planetary gearset disposed along a main gearbox axis, wherein the driveshaft of the first axial flux electric motor is disposed along the main gearbox axis.
the pump is in fluid communication with the first and second clutches.
the first and second clutches are electric clutches, hydraulic clutches or pneumatic clutches.
the second electric motor assembly is an axial flux electric motor and the first electric motor assembly is a radial flux electric motor.
the second electric motor comprises an electric motor and an electric generator.
the auger assembly is vertically oriented.
the auger assembly is horizontally oriented.
the feed mixer platform is a skid.
the feed mixer platform is a wheeled trailer.
the first driveshaft extends along a first axis and the second driveshaft and third driveshaft extend along a second axis, wherein the first gear assembly is disposed along the second axis.
the first driveshaft and one of the second driveshaft or third driveshaft extend along a first axis, wherein the first gear assembly is disposed along the first axis.
a second gear assembly disposed along one of the first axis or second axis, wherein the first axis and the second axis are parallel with one another.
the first axis and the second axis are perpendicular to one another, wherein the first gear assembly is disposed along both of the first axis and the second axis.
the second gear assembly is a right-angle gearbox.

Not all the described processes may be performed in all embodiments of the methods. Additionally, one or more processes that are not expressly illustrated may be included before, after, in between, or as part of the described process. In some embodiments, one or more of the processes may be implemented, at least in part, in the form of executable code stored on non-transitory, tangible, machine-readable media that when run by one or more processes may cause the one or more processors to perform one or more of the processes.

While certain exemplary embodiments of the invention have been described and shown in the accompanying drawings, it is to be understood that such embodiments are merely illustrative and not restricted on the broad disclosure, and that the embodiments of the disclosure are not limited to specific constructions and arrangements shown and described, since various other modifications may occur to those ordinarily skilled in the art.

What is claimed is:

1. A feed mixer assembly comprising:
a feed mixer platform;
a vessel supported on the platform;
an auger assembly extending into the vessel and rotatably mounted relative to the platform;
a main gearbox assembly having an input shaft and an output shaft, the output shaft coupled to the auger;
a first axial flux electric motor assembly having a driveshaft coupled to the input shaft of the main gearbox assembly;
a first inverter mounted on the platform and electrically coupled to the first axial flux electric motor assembly;
an electric battery assembly mounted on the platform and electrically coupled to the first inverter;
a control gearbox assembly mounted on the platform and having a first driveshaft extending along a first axis, a second driveshaft, and a third driveshaft, wherein the first driveshaft is an input shaft, and the second driveshaft is an output shaft;
a pump mounted on the platform and coupled to the second driveshaft;
a second axial flux electric motor assembly mounted on the platform, the second axial flux electric motor assembly coupled to the third driveshaft of the control gearbox assembly; and
a second inverter mounted on the platform and electrically coupled between the second axial flux electric motor assembly and the battery.

2. The assembly of claim 1, wherein the control box assembly comprises a first gear assembly; wherein the second and third driveshafts of the control gearbox assembly are aligned along a second axis with the first gearbox positioned along the second axis; and wherein the first gear assembly is a three-way gearbox.

3. The assembly of claim 1, where the second and third driveshafts of the control gearbox assembly are selectively coupled together.

4. The assembly of claim 1, further comprising an external electricity source electrically coupled to the battery, wherein the external electricity source is a power grid.

5. The assembly of claim 1, further comprising a power source detachably coupled to the first driveshaft of the control gearbox, wherein the power source is an engine or the power take off of a tractor.

6. The assembly of claim 1, wherein the pump is an oil pump or hydraulic pump.

7. The assembly of claim 6, wherein the pump is in fluid communication with the main gearbox assembly.

8. The assembly of claim 1, further comprising at least two auger assemblies, each vertically extending from the hopper base and rotatably mounted relative to the base; at least two main gearbox assemblies, each having an input shaft and an output shaft, the output shaft coupled to an auger; at least two first axial flux electric motor assemblies, each having a driveshaft coupled to the input shaft of a separate main gearbox assembly; and a least two first inverters mounted on the platform, each electrically coupled to a separate one of the first axial flux electric motors.

9. The assembly of claim 3, where the control gearbox assembly further comprises a first clutch to selectively couple the first driveshaft to the third driveshaft and a second clutch to selectively couple the second driveshaft to the third driveshaft.

10. The assembly of claim 1, wherein the main gearbox assembly comprises a planetary gearset disposed along a main gearbox axis, wherein the driveshaft of the first axial flux electric motor is disposed along the main gearbox axis.

11. The assembly of claim 9, wherein the pump is in fluid communication with the first and second clutches.

12. The assembly of claim 9, wherein the first and second clutches are electric clutches, hydraulic clutches or pneumatic clutches.

13. A feed mixer assembly comprising:
a feed mixer platform;
a hopper mounted on the platform;
an auger assembly within the hopper and rotatably mounted relative to the hopper;
a main gearbox assembly having an input shaft and an output shaft, the output shaft coupled to the auger;
a first electric motor assembly having a driveshaft coupled to the input shaft of the main gearbox assembly;
a first inverter mounted on the platform and electrically coupled to the first electric motor assembly;
an electric battery mounted on the platform and electrically coupled to the first inverter;
a control gearbox assembly mounted on the platform and having a first gear assembly, a first driveshaft, a second driveshaft, and a third driveshaft, wherein the first driveshaft is an input shaft and at least two of the first driveshaft, second driveshaft, and third driveshaft extend from the first gear assembly; a pump mounted on the platform and coupled to the second driveshaft; a second electric motor assembly mounted on the platform, the second electric motor assembly coupled to the third driveshaft of the control gearbox assembly; and a second inverter mounted on the platform and electrically coupled between the second electric motor assembly and the battery; wherein at least two of the first driveshaft, second driveshaft, and third driveshaft are aligned along the same axis, and where the first gear assembly is a three-way gearbox.

14. The assembly of claim 13, wherein the second electric motor assembly is an axial flux electric motor and the first electric motor assembly is a radial flux electric motor.

15. The assembly of claim 13, wherein the second electric motor comprises an electric motor and an electric generator.

16. The assembly of claim 13, wherein the auger assembly is vertically oriented.

17. The assembly of claim 13, wherein the auger assembly is horizontally oriented.

18. The assembly of claim 13, wherein the feed mixer platform is a skid.

19. The assembly of claim 13, wherein the feed mixer platform is a wheeled trailer.

20. A farming assembly comprising:
a platform;
an auger assembly at least partially supported on the platform;
a main gearbox assembly having an input shaft and an output shaft, the output shaft coupled to the auger assembly;
a first axial flux electric motor assembly having a driveshaft coupled to the input shaft of the main gearbox assembly;
a first inverter mounted on the platform and electrically coupled to the first axial flux electric motor assembly;
an electric battery assembly mounted on the platform and electrically coupled to the first inverter;
a control gearbox assembly mounted on the platform and having a first driveshaft, a second driveshaft, and a third driveshaft, wherein the first driveshaft is an input shaft and the second driveshaft is an output shaft;
a pump mounted on the platform and coupled to the second driveshaft;
a second axial flux electric motor assembly mounted on the platform, the second axial flux electric motor assembly having a driveshaft coupled to the third driveshaft of the control gearbox assembly; and
a second inverter mounted on the platform and electrically coupled between the second axial flux electric motor assembly and the battery.
